(19) United States
(12) Patent Application Publication
(10) Pub. No.: US 2007/0028160 A1
(43) Pub. Date: Feb. 1, 2007

(54) Re-use wizard

(75) Inventors: Kenneth A. Argo, Redmond, WA (US); Jeffry B. Phillips, Seattle, WA (US); Jie Liu, Woodinville, WA (US); Adrian A. Maziak, Sammamish, WA (US); Mukunda S. Murthy, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/193,298

(22) Filed: Jul. 29, 2005

(51) Int. Cl. G06F 17/00

(52) U.S. Cl. 715/507; 715/705

(57) ABSTRACT

The present application is directed to a re-use wizard. Embodiments of the re-use wizard are directed at recording data input during a wizard session into a stored “template” which may be used to re-use data when the wizard is subsequently executed. More specifically, in one aspect the re-use wizard performs a method that leverages data input during a previous wizard session. In this regard, when a relevant command is identified, the method allows the user to choose among one or more “templates” that may be used to satisfy the command. If the user selects an available template, the method causes data stored in the template to be applied to an application object that is the target of the command. As a result, the user does not need to repetitively enter data when tasks handled by the re-use wizard are scheduled to be performed.

### BACKGROUND

A user interface is a portion of a program with which a user interacts. Types of user interfaces include command-line interfaces, menu-driven interfaces, and graphical user interfaces. A windowing environment, which uses a graphical user interface, is an operating system or shell that presents the user with specially delineated areas of the screen called windows that may be resized and moved around on the display of a computer. The Macintosh OS® and Microsoft Windows® are both examples of windowing environments. Graphical user interfaces (hereinafter “GUIs”) are one of the means by which a user interacts with an application, which is a program designed to assist in the performance of a specific task, such as word processing, accounting, software distribution, and the like.

Wizards are very commonly used within windowing environments and by hundreds of applications that execute in these environments. Those skilled in the art and others will recognize that a wizard is an interactive utility that guides a user through a potentially complex task, typically through a series of question-and-answer dialog boxes. Typically, wizards consist of multiple wizard pages through which a user progresses by clicking on various user interface components such as “Next” and “Back” buttons. Each wizard page provides some information to the user to guide the user through a subset of tasks necessary to complete a larger task. Moreover, typically, the user provides some input on each wizard page that is used by the application program the wizard is designed to service.

Since wizards were introduced, they have gained wide acceptance as a way to guide end users through complex tasks in a simple and uniform manner. As their acceptance has grown, so too, has the complexity of the tasks that wizards have been called upon to perform. In addition, due to increased usage, certain aspects of most wizards, such as their “look and feel,” have become uniform so that windowing environments may be more readily understandable to a user.

Conventional wizards, when in complete form, are easy to navigate and use for even inexperienced end users. However, with the increasing popularity of wizards, users are repetitively entering data into wizard pages that have been previously entered during previous wizard sessions. For example, a user may employ a wizard to interact with a word processing program in order to create a letter. In this instance, the wizard may prompt users for certain data that is used by the word processing program to create the letter. In subsequent wizard sessions, the wizard may prompt -the user for the same data to create a different letter or other document. In this instance, a user is required to repetitively input the same data into the wizard pages even though the data was previously entered in a previous session.

### SUMMARY

The foregoing problems discussed in the Summary are overcome by a re-use wizard, embodiments of which are directed to recording data input during a wizard session in a stored “template” and providing the user with mechanisms for reusing the data when the re-use wizard is subsequently executed. More specifically, in one aspect the re-use wizard performs a method that leverages data input during a previous wizard session. In this regard, when a command handled by the re-use wizard is identified, the method allows the user to choose among one or more “templates” that may be used to satisfy the command. If the user selects one of the available templates, the method causes data stored in the template to be applied to an application object that is the target of the command generated by the user. As a result, the user does not need to repetitively enter data when tasks handled by the re-use wizard are scheduled to be executed.

In another embodiment, the re-use wizard serves as a software system that causes program code to be executed using data that was obtained during a previous wizard session. More specifically, the software system includes (1) a graphical user interface that obtains data from the user; (2) a data store that stores data input into the graphical user interface; and (3) a coordination module operative to cause data input into the graphical user interface to be stored in the data store and recalled when necessary to satisfy a command that is handled by the re-use wizard.

In yet another embodiment, a computer-readable medium is provided with contents, i.e., a program that causes a computer to operate in accordance with the method described herein.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this re-use wizard will become more readily appreciated as the same become better understood by reference to the following detailed description, when taken in conjunction with the accompanying drawings, wherein:

FIG. 1 is a pictorial depiction of an exemplary computer environment in which embodiments of the re-use wizard may be implemented;

FIG. 2 is a block diagram of the distribution server depicted in FIG. 1 that is suitable to illustrate embodiments of the re-use wizard;

FIG. 3 is a flow diagram that illustrates a method for using data that was input during a previous wizard session in accordance with one embodiment of the re-use wizard; and

FIGS. 4A-4C show exemplary wizard pages that are formed in accordance in different embodiments of the re-use wizard.

### DETAILED DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file servers, computer servers and memory storage devices. Each of these conventional distributed computing components is accessible by the processor via a communication network.

Embodiments of the re-use wizard described herein are directed to making a graphical user interface on a computer system more convenient and easier to use. More specifically, the re-use wizard records and re-uses data entered during a wizard session so that program code may be automatically executed when a user issues a command that identifies an application object that varies between wizard sessions. For example, consider a wizard associated with a word processor application that allows a user to generate a letter that includes the date, address of the sender, greetings, and closing statements. Such a wizard may include multiple pages where each page is designed to allow the user to set up a portion of the letter. In this regard, the first wizard page might allow the user to choose the format for the date. The second wizard page might allow the user to choose whether the letter is formal or informal in presentation. Once the wizard pages have been completed, the wizard causes the formatted data to be inserted in a word processing document at locations appropriate for a letter. However, typically with existing systems, users have not been able to “re-use” data that was previously entered into a wizard. For example, if the user wanted to create a second letter that has the same attributes as the first letter, the user would proceed to repetitively input data into the wizard pages to create the same style of letter. However, aspects of the re-use wizard described herein allow a user to “record” a wizard session and re-use data entered during the session. The saved wizard session may be used as a template so that a user may later identify an application object (e.g., word processing document) that should have the same attributes as the template.

While the re-use wizard will primarily be described in the context of making an aspect of a graphical user interface commonly known as a wizard easier to use, those skilled in the relevant art and others will recognize that aspects of the re-use wizard are also applicable to other areas than those described. In any event, the following description first provides an overview of an environment and system in which the re-use wizard may be implemented. Then a method that implements aspects of the re-use wizard is described. The illustrative examples provided herein are not intended to be exhaustive or to limit the claimed subject matter to the precise forms disclosed. Similarly, any steps described herein may be interchangeable with other steps or combinations of steps in order to achieve the same result.

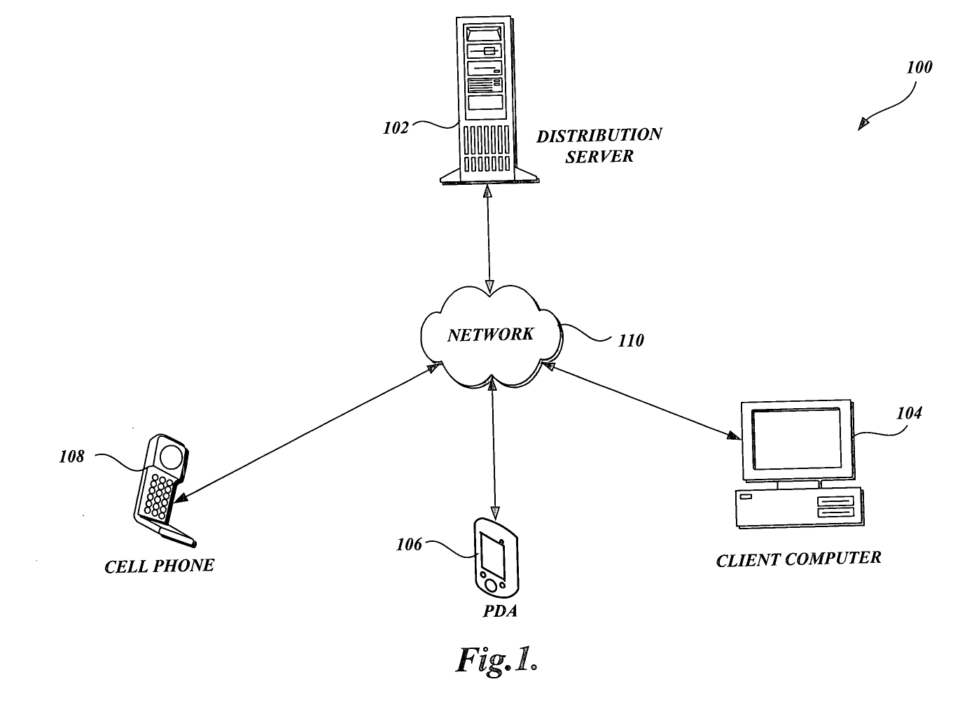

The following discussion is intended to provide a brief, general description of a networking environment 100 suitable to illustrate an exemplary application of the re-use wizard. As illustrated in FIG. 1, the networking environment 100 is comprised of a plurality of computers-namely, the distribution server 102, the client computer 104, the Personal Digital Assistant (“PDA”) 106, and the cell phone 108. Also, the distribution server 102 is configured to communicate with the client computer 104, PDA 106, and the cell phone 108 via the network 110, which may be implemented as a Local Area Network (“LAN”), Wide Area Network (“WAN”), or the global network commonly known as the Internet. As known to those skilled in the art and others, the computers 102, 104, 106, and 108 illustrated in FIG. 1 may be configured to exchange files, commands, and other types of data over the network 110. However, since protocols for network communication, such as TCP/IP, are well known to those skilled in the art of computer networks, those protocols will not be described here.

For the sake of convenience, FIG. 1 illustrates a server computer, a client computer, a PDA, and a cell phone that are usable in the networking environment 100 in which complementary tasks may be performed by remote computers linked together through the communication network 110. However, those skilled in the art will appreciate that the re-use wizard may be practiced with many other computer system configurations. For example, the re-use wizard may be practiced with a personal computer operating in a stand-alone environment or with multiprocessor systems, minicomputers, mainframe computers, and the like. In this regard, the functions performed by the computers described herein, may be implemented by a plurality of computers. In addition to the conventional computer systems illustrated in FIG. 1, those skilled in the art and others will also recognize that the re-use wizard may be practiced on other kinds of computers, including laptop computers, tablet computers, or any device upon which computer software or other digital content may be executed.

Aspects of the re-use wizard may be implemented in a number of different applications of which the following is only an example. In an exemplary application, the re-use wizard is implemented on a server-based computer (e.g., the distribution server 102) in conjunction with a software system that distributes application programs and software updates to client-based computers (e.g., the client computer 104, the PDA 106, and the cell phone 108). In general, the distribution server 102 acts as a distribution point for software that regularly becomes available from a trusted entity. In this regard, the distribution server 102 maintains a software system configured to transmit application programs and software updates from the distribution server 102 to one or more client-based computers connected to the network 110. Moreover, the software system maintains functionality that assists administrators in performing tasks including identifying the software state of client computers connected to the network 110.

In one aspect, the distribution server 102 allows an administrator to customize how application programs and software updates will be installed on the client-based computers. For example, the software system maintained on the distribution server 102 allows a system administrator to customize how software updates will be installed on client computers in an enterprise network. In this regard, the distribution server 102 may be configured to perform installations at predetermined periods of time, thereby minimizing inconvenience to users. Similarly, some types of software updates may be assigned a higher priority than other software updates. For example, software updates to antivirus software may be assigned a high priority level so that they may be installed as soon as they become available. In one exemplary embodiment, aspects of the re-use wizard are implemented on the distribution server 102 to obtain and re-use configuration data that defines how applications and software updates will be installed on client-based computers. However, those skilled in the art and others will recognize that aspects of the re-use wizard may be implemented in other contexts not described herein.

As will be appreciated by those skilled in the art and others, FIG. 1 provides a simplified example of one networking environment 100 suitable for implementing embodiments of the re-use wizard. In other embodiments, the functions and features of the computing systems shown in FIG. 1, e.g., the distribution server 102, the client computer 104, the PDA 106, and the cell phone 108 may be implemented using a greater number of computing systems or reduced to a single computing system and, thus, not require network protocols for communication between combined systems.

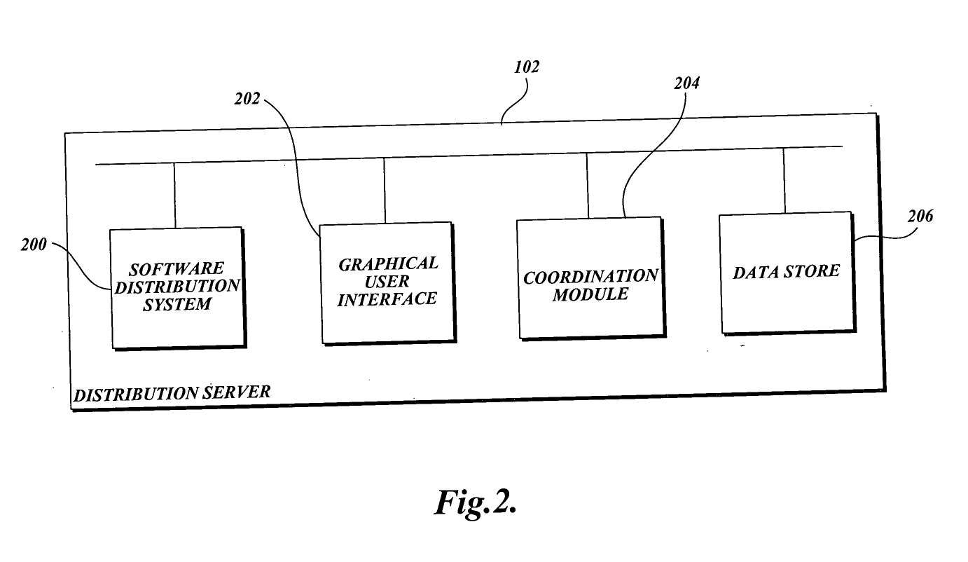

Now, with reference to FIG. 2, an exemplary computer architecture for the distribution server 102 depicted in FIG. 1 will be described. The exemplary computer architecture for the distribution server 102 may be used to implement one or more embodiments of the re-use wizard. For ease of illustration and because it is not important for an understanding of the claimed subject matter, FIG. 2 does not show the typical components of many computers, such as a CPU, keyboard, a mouse, a printer, or other I/O devices, a display, etc. However, as illustrated in FIG. 2, the distribution server 102 does include a software distribution system 200, a graphical user interface (“GUI”) 202, a coordination module 204, and a data store 206.

The depiction of the distribution server 102 illustrated in FIG. 2 includes a software distribution system 200. As described previously with reference to FIG. 1, aspects of the re-use wizard may be implemented in conjunction with a system used by administrators to distribute applications and software updates to computers connected to a network. However, those skilled in the art and others will recognize that the re-use wizard may be implemented in conjunction with other types of applications.

As illustrated in FIG. 2, the distribution server 102 also maintains a graphical user interface (“GUI”) 202 for communicating with a user, such as a system administrator. The GUI 202 is an input system characterized by the use of graphics on a computer display to communicate with a computer user. For example, a series of wizard pages that request data from a user may be displayed by the GUI 202. Also, the GUI 202 allows a system administrator to click buttons, icons, and menu options to generate commands.

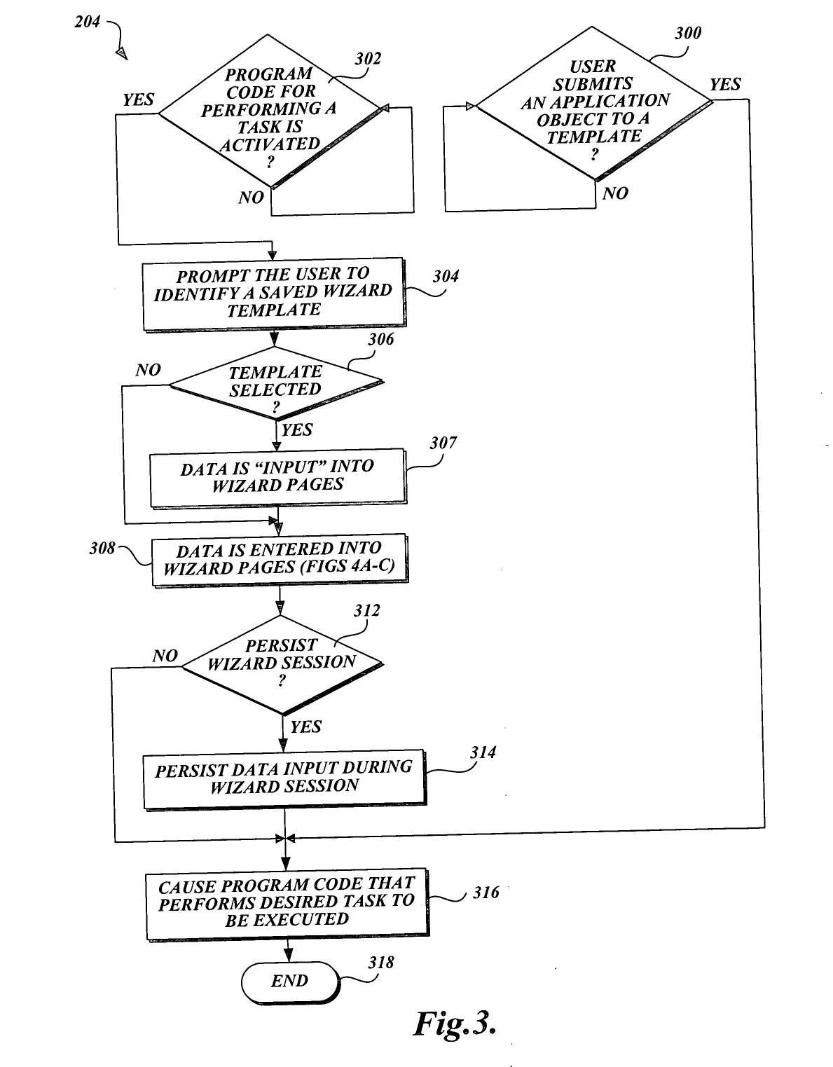

The depiction of the distribution server 102 illustrated in FIG. 2 also includes a coordination module 204. Since functions and different embodiments of the coordination module 204 are described below with reference to FIG. 3, a detailed description of the module 204 will not be provided here. However, generally described, when the module 204 identifies a command handled by the re-use wizard, the module 204 provides logic that allows the user to choose among one or more “templates” that may be used to satisfy the command. If the user selects one of the available templates, the module 204 causes data stored in the data store 206 from a previous wizard session to be applied to an application object that is the target of the command. As a result, the user does not need to repetitively enter data when tasks handled by the re-use wizard are scheduled to be completed.

As illustrated in FIG. 2, each component of the distribution server 102, e.g., the software distribution system 200, the GUI 202, the coordination module 204, and the data store 206 are interconnected and able to communicate with other components. As known to those skilled in the art, FIG. 2 is a simplified example of one computer capable of performing the functions of the re-use wizard. Actual embodiments of the distribution server 102 will have additional components not illustrated in FIG. 2 or described in the accompanying text. Also, FIG. 2 shows one component architecture in which the re-use wizard may be implemented, but other component architectures are possible. Thus, FIG. 2 should be construed as exemplary and not limiting.

Now with reference to FIG. 3, an exemplary embodiment of a coordination module 204 illustrated in FIG. 2 that provides logic for recording and reusing data obtained during a wizard session will be described.

As illustrated in FIG. 3, the coordination module 204 may begin at decision block 300 where it remains idle until the user submits an application object to a wizard session that is saved as a template. Typically, wizards perform a specific series of functions in which only a single application object changes between wizard sessions. For example, a system administrator may regularly receive software updates to antivirus software that are distributed to client-based computers connected to an enterprise network. As described previously, the re-use wizard may be implemented in conjunction with this type of system to automatically distribute the software update based on a saved template without proceeding through a set of “step-by-step” wizard pages. Instead, the user submits the application object (e.g., the identity of the software update) to a wizard session that is saved as a template. In this example, the user may select an icon or other graphical representation associated with a software update and perform a function commonly known as “drag-and-drop,” where an input device such as a mouse is used to associate the software update with a saved template. Then the coordination module 204 proceeds to block 316 described in further detail below.

As illustrated in FIG. 3, the coordination module 204 may begin at decision block 302 where it remains idle until program code that is designed to obtain input regarding the performance of a task is activated. The coordination module 204 may begin performing functions in a variety of different circumstances. In one instance, the user causes program code that is designed to obtain input regarding the performance of the task to be activated. Modem application programs are primarily event driven in that program code is activated when a specified event occurs. For example, a user may choose to issue a command inside an application program by selecting an item maintained in a drop-down menu. In this instance, the item selected is identified by the operating system and communicated to program code that is designed to satisfy the command generated by the user in selecting the item in the drop-down menu. However, since event-driven systems that may be used to activate program code are generally known in the art, further description of these systems is not provided here. Moreover, those skilled in the art and others will recognize that program code may be activated, at block 302, in other instances that are generally known in the art.

Generally described, a wizard is any utility that uses a “step-by-step” method to obtain input from a user for the purpose of accomplishing a task. Typically, wizards obtain input using a plurality of graphically based dialog boxes that support various types of interactive input mechanisms (e.g., text boxes, check boxes, buttons, etc.). Similarly, the coordination module 204 may obtain input using a plurality of graphically based dialog boxes or similar input mechanisms when a command is generated from within an application. However, as described in reference to block 302, the coordination module 204 may also perform functions in other instances without obtaining input through the use of a traditional wizard interface.

At block 304, the coordination module 204 prompts the user to identify a saved wizard template. If block 304 is reached, program code that is designed to obtain input regarding a task handled by the coordination module 204 is activated at block 302. In this instance, the user is prompted with at least one wizard page that requests input regarding whether a saved template should be used in order to perform the task requested by the user. In the example described above that involves software updates, a system administrator may select a software update in an application program that will be distributed to client-based computers connected to a network. In this instance, at block 304 the coordination module 204 generates and displays a wizard page that requests input regarding whether an existing template should be used to distribute the software update. As mentioned previously, a system administrator may define a plurality of templates for distributing software updates such as templates designed for critical software updates that are installed as soon as they become available or software updates that are distributed and installed at a time that minimizes the inconvenience to users.

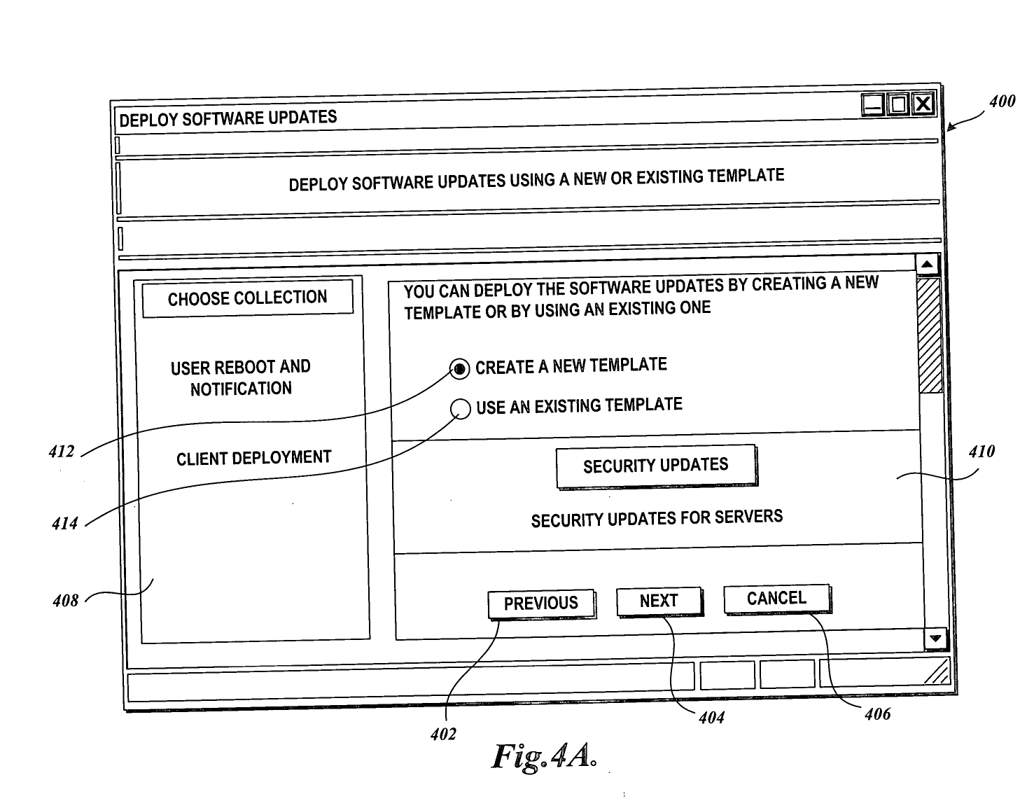

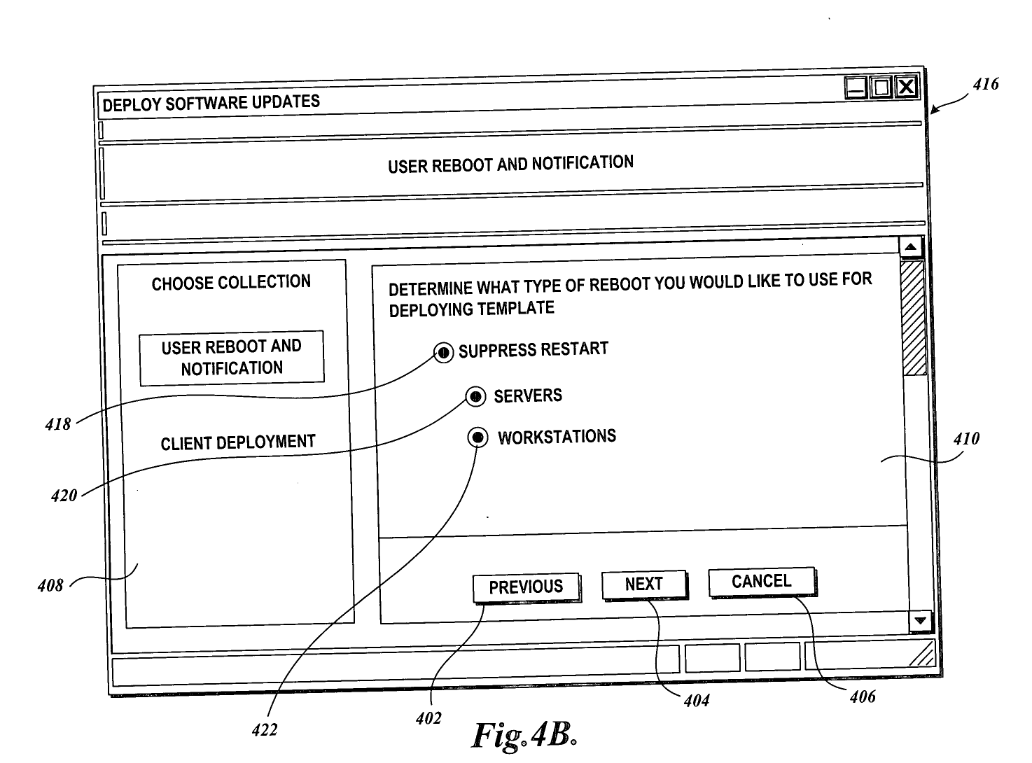

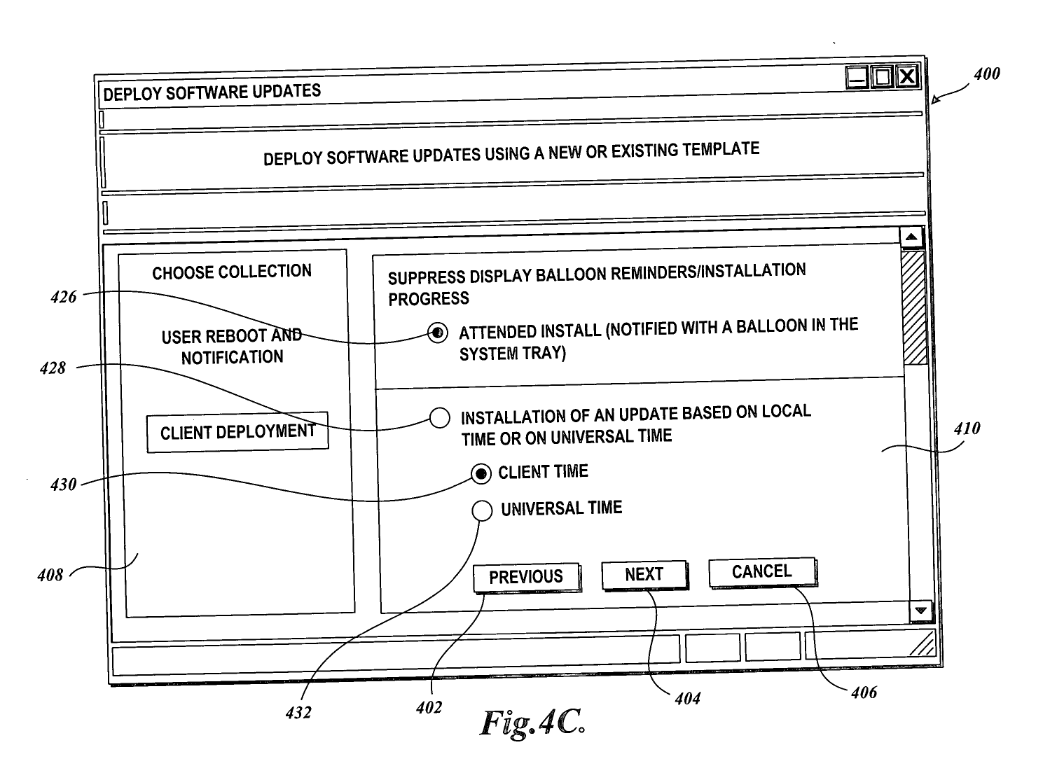

At decision block 306, the coordination module 204 determines whether the user selected a template at block 304 to perform a task that is handled by the re-use wizard. As described above and illustrated in FIG. 4A (described below), the wizard page displayed at block 304 provides an option of choosing an existing template and/or entering data manually using a plurality of “step-by-step” wizard pages. If the user chose an existing template for performing the task, the coordination module 204 proceeds to block 307. Conversely, if the user did not select an existing template to perform the task, the coordination module 204 proceeds to block 308.

Returning to FIG. 3, at block 307 data needed to perform the task handled by the re-use wizard is automatically “input” into a set of wizard pages by aspects of the re-use wizard. If block 307 is reached, the user selected a template, at block 304, to perform a task. If all of the data that is required to perform the task is known, all of the wizard pages may be presented to the user so that data stored in the template is entered as “default” values. Stated differently, the re-use wizard retrieves data stored in a template or data store and “pre-fills” the data into the relevant sections of the wizard pages, at block 307, which will later be displayed to the user. However, in an alternative embodiment, when all of the data that is needed to perform a task handled by the re-use wizard is known, wizard pages may not be displayed to the user. Instead, the coordination module 204 may bypass block 307 and proceed directly to block 316 where the desired task is performed. Obviously, in this instance, the values maintained in the template are used to perform the task without being modified by the user.

In some instances, all of the data needed to perform a task handled by the re-use wizard is not known when block 307 is reached. For example, a user may save a template so that certain types of information are required to be input by the user during a wizard session. Moreover, the application object that will be used to perform the desired task may not have been previously selected by the user. In instances when all of the required data is not known, data stored in the template, selected at block 304, may be “pre-filled” in the relevant portions of the wizard pages that are displayed to the user. This enables a user to quickly proceed through a set of wizard pages, filling in the required data and potentially modifying data that was provided as a default value.

At block 308, a set of wizard pages is displayed and data needed to perform the task handled by the re-use wizard may be input into the set of wizard pages by the user. When block 308 is reached, entries in the wizard pages may be pre-filled if the user selected a template at block 304. Alternatively, the user may be required to input data into the set of pages at block 308. In any event, as mentioned previously, aspects of the re-use wizard may be implemented in conjunction with any number of different application programs to make a computer more user-friendly. However, since creating and displaying a set of wizard pages that are designed to obtain data from a user are generally known in the art, additional description of the techniques used to obtain input from the user at block 308 will not be described in further detail here. However, once all of the necessary data is entered, the coordination module 204 proceeds to block 312, described below.

For illustrative purposes and by way of example only, exemplary wizard pages are illustrated in FIGS. 4A-4C that may be used to obtain data from a user. FIG. 4A shows an initial wizard page 400 that includes a previous button 402, a next button 404, a cancel button 406, a left panel 408, a right panel 410, and radio buttons 412 and 414. In this exemplary embodiment, the radio buttons 412 and 414 allow the user to determine whether to create a new template or use an existing template when distributing and installing a software update to client-based computers connected to a network. Thus, the wizard page 400 illustrated in FIG. 4A may be the type of page that is displayed to the user by the coordination module 204 at block 304. In any event, if the user selects radio button 414, an existing template may also be selected that will be used to distribute a software update. The existing templates are only accessible to the user in the right panel 410 when the radio button 414 is selected. The left panel 408 may be used for traversing forward or backward among different wizard pages. Similarly, the previous button 402 and next button 404 may also be used to traverse among different wizard pages. However, since the wizard page 400 is the first to be displayed to the user, the previous button 402 is not accessible to the user from wizard page 400. Finally, the cancel button 406 may be activated in order to exit from the current wizard session.

FIG. 4B shows a wizard page 416 with many of the same components as illustrated in FIG. 4A. However, wizard page 416 includes radio buttons 418, 420, and 422 that depict the type of information that may be displayed if the user chooses to distribute an application or software update by manually entering data instead of using an existing template. In this instance, the wizard page 416 requests input regarding settings that define how an application or software update will be distributed. As mentioned above, the user may save this type of wizard session in a template so that data is not re-entered in a subsequent session in which a user wants to distribute another application or software update using the same settings.

FIG. 4C illustrates a wizard page 424 with many of the same components depicted in FIGS. 4A-B, but includes radio buttons 426, 428, 430, 432 for obtaining additional input from the user. Similar to FIG. 4B, wizard page 424 depicts the type of information that may be displayed if the user chose to install an application or software update by manually entering data instead of using an existing template. Those of ordinary skill in the art, of course, will appreciate that many other components than those shown in FIGS. 4A-C may be included in a set of wizard pages.

With reference to FIG. 3, at decision block 312, the coordination module 204 determines whether the current wizard session should be persisted or saved on a storage device. In one embodiment, the user is presented with a wizard page in which the user selects whether data input during the current wizard session should be persisted. However, those skilled in the art and others will recognize that the determination of whether to persist a wizard session may be made in other ways without departing from the scope of the claimed subject matter. If the wizard session will not be persisted, the coordination module 204 proceeds to block 316, described below. Conversely, if the wizard session will be persisted, the module 204 proceeds to block 312.

As illustrated in FIG. 3, at block 314 the coordination module 204 causes data that was input during a wizard session to be persisted or stored in a data store that serves as a template. In one embodiment, data entered by the user is formatted into a self-describing data format, such as the eXtensible Markup Language (“XML”), and saved in a file that is stored on a storage device. Those skilled in the art and others will recognize that self-describing data formats such as XML allow software engineers to describe the structure of data-for example, by using their own customized tags, to facilitate easy validation and interpretation of data between software systems. As a consequence, a set of data entered by the user may be “recorded” in an XML document that is capable of being recalled at a later time when program code implemented by an application is scheduled to be executed.

At block 316, program code associated with an application that implements the re-use wizard is executed. As mentioned previously, aspects of the re-use wizard may be implemented in conjunction with any number of currently existing or yet to be developed applications that obtain data from a user using a “step-by-step” input system (e.g., a wizard). At block 316, after all of the data necessary to execute the desired task is obtained by the coordination module 204, the data is made available to the appropriate application that executes program code to perform the desired task. Then coordination module 204 proceeds to block 318 where it terminates.

It should be well understood that aspects of the re-use wizard as described herein may be performed in different ways without departing from the claimed subject matter. For example, steps in the coordination module 204 described above with reference to FIG. 3 may be performed in a different order than described. Moreover, certain steps may be omitted or added to the coordination module 204 without departing from the scope of the claimed subject matter. For example, as mentioned previously, block 312 of the coordination module 204 may be omitted in certain circumstances, depending on whether additional data needs to be obtained from the user.

While the preferred embodiment of the re-use wizard has been illustrated and described, it will be appreciated that various changes can be made therein without departing from the claimed subject matter.

The embodiments of the invention in which is an exclusive property or privilege is claimed are defined as follows:

1. A method implemented in a computer for using data to perform a task that was input into the computer during a wizard session, the method comprising:
(a) storing data input into the computer during the wizard session;
(b) in response to identifying a command to perform the task:
(i) recalling the data input during the wizard session; and
(ii) identifying an application object that is the target of the command; and
(c) performing the task using the application object that is the target of the command and data input during the wizard session.

2. The method as recited in claim 1, wherein the task is executed automatically without obtaining additional input from the user in response to the command.

3. The method as recited in claim 1, wherein the user issues the command by selecting a graphical representation of the application object using an input device and associates the graphical representation of the application object with a graphical representation of a template that stores data input during the wizard session.

4. The method as recited in claim 1, wherein the computer is a server-based computer and the command is directed in distributing software to a client-based computer connected to a network.

5. The method as recited in claim 1, wherein the user issues the command by selecting a graphical user interface element in an application; and
wherein the data input during the wizard session is provided to the application to perform the task.

6. The method as recited in claim 1, wherein:
(a) the task is executed after a subsequent wizard session in which the user has the ability to modify the data entered during the subsequent wizard session; and
(b) the data entered during the first wizard session is displayed to the user as default values.

7. The method as recited in claim 1, wherein storing data input during the wizard session includes representing the data in a data store that complies with the eXtensible Markup Language.

8. The method as recited in claim 1, wherein storing data input during the wizard session includes:
(a) displaying a set of wizard pages to the user that prompts the user for the data; and
(b) translating the data input by the user in a self-describing data format.

9. A computer-readable medium bearing computer-executable instructions which, when executed, carry out a method for using data to perform a task that was input into the computer during a wizard session, the method comprising:
(a) storing data input into the computer during the wizard session;
(b) in response to identifying a command to perform the task:
(i) recalling the data input during the wizard session; and
(ii) identifying an application object that is the target of the command; and
(c) performing the task using the application object that is the target of the command and data input during the wizard session.

10. The computer-readable medium as recited in claim 9, wherein the task is executed automatically without obtaining additional input from the user in response to the command.

11. The computer-readable medium as recited in claim 9, wherein the user issues the command by selecting a graphical representation of the application object using an input device and associates the graphical representation of the application object with a graphical representation of a template that stores data input during the wizard session.

12. The computer-readable medium as recited in claim 9, wherein the computer is a server-based computer and the command is directed in distributing software to a client-based computer connected to a network.

13. The computer-readable medium as recited in claim 9, wherein the user issues the command by selecting a graphical user interface element in an application; and
wherein the data input during the wizard session is provided to the application to perform the task.

14. The computer-readable medium as recited in claim 9, wherein:
(a) the task is executed after a subsequent wizard session in which the user has the ability to modify the data entered during the subsequent wizard session; and
(b) the data entered during the first wizard session is displayed to the user as default values.

15. The computer-readable medium as recited in claim 9, wherein storing data input during the wizard session includes representing the data in a data store that complies with the eXtensible Markup Language.

16. The computer-readable medium as recited in claim 9, wherein storing data input during the wizard session includes:
(a) displaying a set of wizard pages to the user that prompts the user for the data; and
(b) translating the data input by the user in a self-describing data format.

17. A software system for performing a task using data obtained during a first wizard session, the software system comprising:
(a) a graphical user interface- capable of obtaining input from the user using graphical display elements;
(b) a data store operative to store data input into the graphical user interface in a format that may be exchanged between software systems; and
(c) a coordination module operative to:
(i) cause data input into the graphical user interface during the wizard session to be stored in the data store; and
(ii) provide the data to an application when the task is identified.

18. The software system as recited in claim 17, further comprising a software distribution system operative to use data that is managed by the coordination module to distribute software to a client-based computer that is connected to a network.

19. The software system as recited in claim 17, wherein the data store maintains data in the eXtensible Markup Language.

20. The software system as recited in claim 17, wherein the coordination module is further configured to execute the task automatically without obtaining input from the user to describe settings which dictate how the task will be performed.
